(19) United States
(12) Patent Application Publication
(10) Pub. No.: US 2020/0218109 A1
(43) Pub. Date: Jul. 9, 2020

(54) REFLECTIVE DISPLAY PANEL, AND METHOD OF FABRICATING, METHOD OF DRIVING AND DISPLAY APPARATUS USING THE SAME

(71) Applicant: BOE TECHNOLOGY GROUP CO., LTD., Beijing (CN)

(72) Inventors: Yoonsung Um, Beijing (CN); Yue Jia, Beijing (CN); Shunhang Zhang, Beijing (CN); Liwei Liu, Beijing (CN); Feng Liao, Beijing (CN); Hui Zhang, Beijing (CN); Hongrun Wang, Beijing (CN); Kai Hou, Beijing (CN)

(21) Appl. No.: 16/553,029

(22) Filed: Aug. 27, 2019

(30) Foreign Application Priority Data
Jan. 3, 2019 (CN) 201910005727.1

(51) Int. Cl. G02F 1/137; G02F 1/1335

(52) U.S. Cl. CPC G02F 1/13718; G02F 1/133553; G02F 1/133536

(57) ABSTRACT

A reflective display panel includes an array substrate and an opposite substrate disposed, wherein a photoelectric material layer is disposed between the array substrate and the opposite substrate, and the reflective display panel is divided into a plurality of pixel areas, both a solar cell layer and a light adjustment layer are disposed on a side of the photoelectric material layer, and the light adjustment layer is disposed between the solar cell layer and the photoelectric material layer, and the light adjustment layer comprises a light adjustment portion located in each of the pixel areas, and the light adjustment portion, when the pixel area is in a display state, reflects at least a part of light emitted from the photoelectric material layer toward the light adjustment portion, and when the pixel area is in a non-display state, transmits the light emitted from the photoelectric material layer.

### CROSS REFERENCE

This application is based upon and claims priority to Chinese Patent Application No. 201910005727.1, filed on Jan. 3, 2019, the entire content thereof are incorporated herein by reference.

### TECHNICAL FIELD

The present disclosure relates to the field of display technologies, particularly to a reflective display panel, and a method of fabricating the same, a method of driving the same and a display apparatus using the same.

### BACKGROUND

In existing technology of displays having solar cells, solar cells are integrated above the black matrix of a color film substrate. However, this structure makes light collection area of the solar cell relatively small, thus limiting the generated photocurrent.

### SUMMARY

The present disclosure provides a reflective display panel, a method of fabricating the same, a method of driving the same and a display apparatus using the same.

The present disclosure provides a reflective display panel, including: an array substrate; an opposite substrate; a photoelectric material layer; a solar cell layer; and a light adjustment layer. The array substrate and the opposite substrate are disposed opposite to each other. The photoelectric material layer is disposed between the array substrate and the opposite substrate. The reflective display panel is divided into a plurality of pixel areas. Both the solar cell layer and the light adjustment layer are disposed on a side of the photoelectric material layer, falling away from the opposite substrate. The light adjustment layer is disposed between the solar cell layer and the photoelectric material layer. The light adjustment layer includes a light adjustment portion located in each of the pixel areas. The light adjustment portion is configured to, when the pixel area is in a display state, reflect at least a part of light emitted from the photoelectric material layer toward the light adjustment portion, and when the pixel area is in a non-display state, transmit the light emitted from the photoelectric material layer toward the light adjustment portion.

In some arrangements, a circular polarizer is disposed on a side of the opposite substrate, falling away from the photoelectric material layer. The photoelectric material layer includes a nematic liquid crystal layer. The reflective display panel further includes a driving electrode layer. The driving electrode layer is configured to apply an electric field to the nematic liquid crystal layer, so as to use the nematic liquid crystal layer to transform light from the circular polarizer, between polarization states of left-rotation circularly-polarized light and right-rotation circularly-polarized light.

In some arrangements, the light adjustment portion includes a cholesteric liquid crystal layer.

In some arrangements, the cholesteric liquid crystal layer includes a first cholesteric liquid crystal layer of a solid state. The first cholesteric liquid crystal layer is configured to reflect one of the left-rotation circularly-polarized light and the right-rotation circularly-polarized light, and transmit the other one of the left-rotation circularly-polarized light and the right-rotation circularly-polarized light.

In some arrangements, the array substrate includes a first substrate and a thin-film transistor disposed on the first substrate, the first cholesteric liquid crystal layer is disposed between the thin-film transistor and the driving electrode layer. The solar cell layer is disposed between the first cholesteric liquid crystal layer and the first substrate.

In some arrangements, the first cholesteric liquid crystal layer includes chiral material with a birefringence index greater than or equal to 5.

In some arrangements, the cholesteric liquid crystal layer is in a liquid state. The light adjustment portion further includes a first transparent electrode layer and a second transparent electrode layer. The first transparent electrode layer and the second transparent electrode layer are configured to provide an electric field to the cholesteric liquid crystal layer, so as to control the cholesteric liquid crystal layer to be in a planar texture state or a focal conic texture state. The cholesteric liquid crystal layer includes a second cholesteric liquid crystal layer. The second cholesteric liquid crystal layer is configured to, when the second cholesteric liquid crystal layer is in the focal conic texture state, transmit incident light, and when the second cholesteric liquid crystal layer is in the planar texture state, reflect the incident light. Or, the cholesteric liquid crystal layer includes a third cholesteric liquid crystal layer. The third cholesteric liquid crystal layer is configured to, when the third cholesteric liquid crystal layer is in the focal conic texture state, transmit the incident light, and when the third cholesteric liquid crystal layer is in the planar texture state, reflect one of the left-rotation circularly-polarized light and the right-rotation circularly-polarized light, and transmit the other one of the left-rotation circularly-polarized light and the right-rotation circularly-polarized light.

In some arrangements, the second cholesteric liquid crystal layer includes chiral material with a birefringence index less than or equal to 0.5. The third cholesteric liquid crystal layer includes chiral material with a birefringence index greater than or equal to 5.

In some arrangements, the reflective display panel according to claim further includes a third substrate disposed on a side of the array substrate, falling away from the opposite substrate. The cholesteric liquid crystal layer in the liquid state is located between the array substrate and the third substrate.

In some arrangements, liquid crystal in the cholesteric liquid crystal layer is wideband cholesteric liquid crystal, the opposite substrate includes a color light-filtering layer, and the color light-filtering layer includes a light-filtering portion located in each of the pixel areas.

In some arrangements, the present disclosure further provides a display apparatus, including the above reflective display panel.

In some arrangements, the present disclosure further provides a method of fabricating the above reflective display panel. The method includes:

fabricating the array substrate and the opposite substrate respectively; disposing the array substrate and the opposite substrate opposite to each other; forming the photoelectric material layer located between the array substrate and the opposite substrate; and forming the solar cell layer and the light adjustment layer respectively, such that both the solar cell layer and the light adjustment layer are located on the side of the photoelectric material layer, falling away from the opposite substrate, and the light adjustment layer is located between the solar cell layer and the photoelectric material layer.

In some arrangements, the light adjustment layer includes a light adjustment portion located in each of the pixel areas. The light adjustment portion includes a cholesteric liquid crystal layer, the cholesteric liquid crystal layer includes a first cholesteric liquid crystal layer of a solid state. Forming the light adjustment layer includes forming the first cholesteric liquid crystal layer of a liquid state on the side of the array substrate, adjacent to the opposite substrate; and solidifying the first cholesteric liquid crystal layer, to form the first cholesteric liquid crystal layer in each of the pixel areas.

In some arrangements, the present disclosure further provides a method of driving the above reflective display panel. The method includes when the pixel area is in the display state, reflecting, via the light adjustment portion, at least a part of the light emitted from the photoelectric material layer toward the light adjustment portion; and when the pixel areas are in the non-display state, transmitting, via the light adjustment portion, the light emitted from the photoelectric material layer toward the light adjustment portion.

In some arrangements, the light adjustment layer includes a light adjustment portion located in each of the pixel areas. The light adjustment portion includes a cholesteric liquid crystal layer. The cholesteric liquid crystal layer includes a first cholesteric liquid crystal layer of a solid state, and light that the first cholesteric liquid crystal layer is able to reflect is a first polarized light, and light that the first cholesteric liquid crystal layer is able to transmit is a second polarized light. Reflecting, via the light adjustment portion, at least a part of the light emitted from the photoelectric material layer toward the light adjustment portion includes applying an electric field to the photoelectric material layer by using the driving electrode layer, such that the photoelectric material layer adjusts the light emitted from the circular polarizer into the first polarized light or elliptically-polarized light. Transmitting, via the light adjustment portion, the light emitted from the photoelectric material layer toward the light adjustment portion includes applying an electric field to the photoelectric material layer by using the driving electrode layer, such that the photoelectric material layer adjusts the light emitted from the circular polarizer into the second polarized light.

In some arrangements, the light adjustment layer includes a light adjustment portion located in each of the pixel areas, the light adjustment portion includes a cholesteric liquid crystal layer, the cholesteric liquid crystal layer is in a liquid state. The light adjustment portion further includes a first transparent electrode layer and a second transparent electrode layer. The first transparent electrode layer and the second transparent electrode layer are configured to provide an electric field to the cholesteric liquid crystal layer, so as to control the cholesteric liquid crystal layer to be in a planar texture state or a focal conic texture state. The cholesteric liquid crystal layer includes a second cholesteric liquid crystal layer or a third cholesteric liquid crystal layer. When the cholesteric liquid crystal layer includes the second cholesteric liquid crystal layer, reflecting, via the light adjustment portion, at least a part of the light emitted from the photoelectric material layer toward the light adjustment portion includes adjusting a voltage between the first transparent electrode layer and the second transparent electrode layer, to control the second cholesteric liquid crystal layer to be in the planar texture state, and transmitting, via the light adjustment portion, the light emitted from the photoelectric material layer toward the light adjustment portion includes adjusting the voltage between the first transparent electrode layer and the second transparent electrode layer, to control the second cholesteric liquid crystal layer to be in the focal conic texture state. When the cholesteric liquid crystal layer includes the third cholesteric liquid crystal layer, light that the third cholesteric liquid crystal layer being in the planar texture state is able to reflect is a first polarized light, and light that the third cholesteric liquid crystal layer is able to transmit is a second polarized light, reflecting, via the light adjustment portion, at least a part of the light emitted from the photoelectric material layer toward the light adjustment portion includes adjusting the voltage between the first transparent electrode layer and the second transparent electrode layer, to control the third cholesteric liquid crystal layer to be in the planar texture state, at the same time, applying an electric field to the photoelectric material layer by using the driving electrode layer, such that the photoelectric material layer adjusts the light emitted from the circular polarizer into the first polarized light or elliptically-polarized light, and transmitting, via the light adjustment portion, the light emitted from the photoelectric material layer toward the light adjustment portion includes: keeping the third cholesteric liquid crystal layer in the planar texture state, at the same time, applying an electric field to the photoelectric material layer by using the driving electrode layer, such that the photoelectric material layer adjusts the light from the circular polarizer into the second polarized light, or adjusting the voltage between the first transparent electrode layer and the second transparent electrode layer, to control the third cholesteric liquid crystal layer to be in the focal conic texture state.

### BRIEF DESCRIPTION OF THE DRAWINGS

The accompanying drawings are provided for further understanding of the present disclosure, form a part of the specification, and used to explain the present disclosure together with the following specific arrangements, yet do not constitute limitations to the present disclosure. In the accompanying drawings:

FIG. 1 is a structural schematic diagram of a reflective display panel according to a first arrangement of the present disclosure;

FIG. 2 is a schematic diagram of a first specific structure of the reflective display panel according to the first arrangement of the present disclosure;

FIG. 3a is a first schematic diagram of the principle on which a pixel area of the reflective display panel in FIG. 2 realizes a bright state;

FIG. 3b is a first schematic diagram of the principle on which a pixel area of the reflective display panel in FIG. 2 realizes a dark state;

FIG. 4a is a second schematic diagram of the principle on which a pixel area of the reflective display panel in FIG. 2 realizes a bright state;

FIG. 4b is a second schematic diagram of the principle on which a pixel area of the reflective display panel in FIG. 2 realizes a dark state;

FIG. 5 is a schematic diagram of a second structure of a reflective display panel according to the first arrangement of the present disclosure;

FIG. 6 is a schematic diagram illustrating that a second cholesteric liquid crystal layer is in different states;

FIG. 7 is a schematic diagram of a third structure of a reflective display panel provided by the disclosure;

FIG. 8 is a schematic diagram illustrating that a third cholesteric liquid crystal layer is in a planar texture state and a focal conic texture state;

FIG. 9a is a first schematic diagram of the principle on which a pixel area of the reflective display panel in FIG. 7 realizes a bright state;

FIG. 9b is a first schematic diagram of the principle on which a pixel area of the reflective display panel in FIG. 7 realizes a dark state;

FIG. 9c is a second schematic diagram of the principle on which a pixel area of the reflective display panel in FIG. 7 realizes a bright state;

FIG. 9d is a second schematic diagram of the principle on which a pixel area of the reflective display panel in FIG. 7 realizes a dark state;

FIG. 10 is a first flow chart illustrating the fabrication of a reflective display panel according to a second arrangement of the present disclosure;

FIGS. 11a to 11i are schematic diagrams illustrating the process for fabricating a reflective display panel by adopting the fabricating method in FIG. 10;

FIG. 12 is a second flow chart illustrating the fabrication of a reflective display panel according to the second arrangement of the present disclosure; and

FIGS. 13a to 13f are schematic diagrams illustrating the process for fabricating a reflective display panel by adopting the fabricating method in FIG. 12.

### DETAILED DESCRIPTION

The arrangements of the present disclosure will be described in details in combination with the accompanying drawings hereinafter. It should be understood that specific arrangements described here are merely used to illustrate and explain the present disclosure, and are not used to limit the present disclosure.

In current display apparatuses using solar cells, in order to improve integration density of the display apparatuses, the solar cells are usually integrated with the display panels. At this time, the display panels adopt reflective display panels, that is, the pixel electrode on the array substrate is a reflective electrode. In this case, if the solar cells are disposed on the side of the array substrate, since the reflective electrode is opaque, the solar cell cannot collect light. Therefore, in order to ensure that the solar cells can receive light and do not affect normal display of the display panel, at present, the solar cells are generally integrated in a position of the black matrix on a color film substrate. However, in order to ensure display, the black matrix generally occupies a relatively small area, so, when the solar cells are disposed in the area occupied by the black matrix, the solar cells will have a relatively small light collection area, and the generated photocurrent is limited as well.

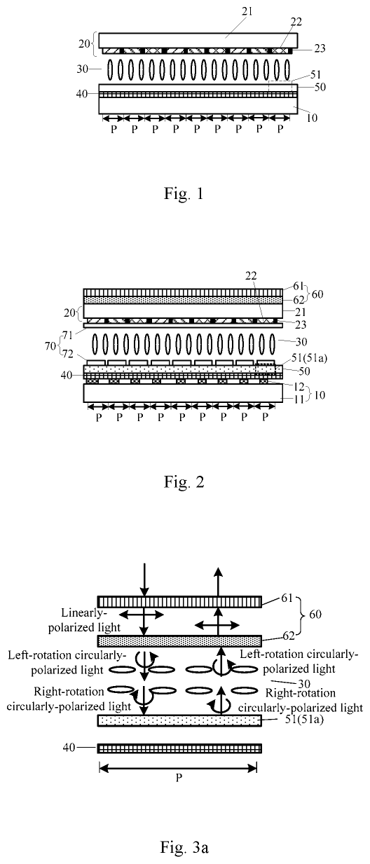

A first arrangement of the present disclosure provides a reflective display panel. FIG. 1 is a structural schematic diagram of a reflective display panel according to the first arrangement of the present disclosure. As shown in FIG. 1, the reflective display panel is divided into a plurality of pixel areas P, and the reflective display panel includes an array substrate 10 and an opposite substrate 20 disposed in opposite to each other. A photoelectric material layer 30 is disposed between the array substrate 10 and the opposite substrate 20, and specifically the photoelectric material layer 30 may be liquid crystal 30. A side of the photoelectric material layer 30, falling away from the opposite substrate 20, is provided with a solar cell layer 40 and a light adjustment layer 50. The light adjustment layer 50 is disposed between the solar cell layer 40 and the photoelectric material layer 30. The light adjustment layer 50 includes light adjustment portions 51 located in the respective pixel areas P. The light adjustment portion 51 is configured to, when the pixel area P is in a display state, reflect at least a part of light emitted from the photoelectric material layer 30 toward the light adjustment portion 51, and when the pixel area P is in a non-display state, transmit light emitted from the photoelectric material layer 30 toward the light adjustment portion 51.

The display state is a state in which there is light emitted out, and a non-display state is a state in which there is no light emitted out, that is, a dark state. When the reflective display panel is used for a display product such as an e-book, a tablet, etc., the display state is a bright state, that is, brightness of the pixel area P is up to the maximum (i.e., L255) state. When the reflective display panel is used for a display product capable of displaying different gradation, such as a mobile phone, a computer, etc., the display state may include a bright state and an intermediate state. The intermediate state is a state in which brightness of the pixel area P is between 0 and the maximum brightness.

In the first arrangement, the light adjustment portion 51 may, when the pixel area P is in a non-display state, transmit light emitted from the photoelectric material layer 30 toward the light adjustment portion 51, and when the pixel areas P are in a display state, reflect at least a part of light emitted from the photoelectric material layer 30 toward the light adjustment portion 51, the solar cell layer 40 may receive light when the pixel area P is in a non-display state, so as to form photocurrent; and when the pixel area P is in a display state, reflect back at least a part of light of the pixel area P, such that corresponding brightness of the pixel area P can be seen on a display side of the reflective display panel. Therefore, the solar cell layer 40 does not need to be integrated in the black matrix as that in the prior art, but may be disposed in the pixel areas P, thus increasing light collection area of the solar cell layer and increasing photocurrent.

Preferably, an orthographic projection of the solar cell layer 40 on the array substrate 10 covers the entire display area of the array substrate 10, so as to maximize light collection area of the solar cell layer 40.

FIG. 2 is a schematic diagram of a first specific structure of a reflective display panel according to a first arrangement of the present disclosure. As shown in FIG. 2, the array substrate 10 includes a first substrate 11, gate lines disposed on the first substrate 11, data lines and thin-film transistors 12. A circular polarizer 60 is further disposed on a side of the opposite substrate 20, falling away from the photoelectric material layer 30. The circular polarizer 60 may convert external light into circularly-polarized light, specifically, into left-rotation circularly-polarized light or right-rotation circularly-polarized light.

Specifically, the circular polarizer 60 may include a linear polarizer 61 and a quarter wave plate 62 located between the linear polarizer 61 and the opposite substrate 20. The optical axis of the quarter wave plate 62 is against the transmission axis of the linear polarizer 61 at 45 degrees. After passing through the linear polarizer 61, the external light may form linearly-polarized light, and after passing through the quarter wave plate 62, the linearly-polarized light may become circularly-polarized light. If the optical axis of the quarter-wave plate 62 is rotated rightward (clockwise) by 45° with respect to the transmission axis of the linear polarizer 61, the external light may be converted into the right-rotation circularly-polarized light. Conversely, if the optical axis of the quarter-wave plate 62 is rotated leftward (counterclockwise) by 45° with respect to the transmission axis of the linear polarizer 61, the external light may be converted into the left-rotation circularly-polarized light.

Specifically, the photoelectric material layer 30 may be a nematic liquid crystal layer. At this time, the reflective display panel may further include a driving electrode layer 70. The driving electrode layer 70 is configured to apply an electric field to the nematic liquid crystal layer, so as to use the nematic liquid crystal layer to transform light from the circular polarizer 60 between polarization states of left-rotation circularly-polarized light and right-rotation circularly-polarized light. When the pixel area P is in a bright state, light emitted from the circular polarizer 60 is adjusted to left-rotation circularly-polarized light by a portion of the photoelectric material layer 30 corresponding to the pixel area P. When the pixel area P is in a non-display state (i.e., dark state), light emitted from the circular polarizer 60 is adjusted to right-rotation circularly-polarized light by a portion of the photoelectric material layer 30 corresponding to the pixel area P. Alternatively, when the pixel area P is in a bright state, light emitted from the circular polarizer 60 is adjusted to right-rotation circularly-polarized light, and when the pixel area P is in a non-display state, light emitted from the circular polarizer 60 is adjusted to left-rotation circularly-polarized light. It should be noted that, when the pixel area P is in an intermediate state between the bright state and the dark state, a polarization state of the light emitted from the circular polarizer 60 after passing through the liquid crystal layer 30 is an intermediate state when the left-rotation circularly-polarized light is being converted to the right-rotation circularly-polarized light. Light in the intermediate state may be the left-rotation circularly-polarized light and/or the right-rotation circularly-polarized light.

Specifically the driving electrode layer 70 includes pixel electrodes 72 and a common electrode 71, and each of the pixel areas P is provided with a pixel electrode 72. In order to prevent the driving electrode layer 70 from affecting light collection of the solar cell layer 40, preferably, both the pixel electrodes 72 and the common electrode 71 may be made of transparent materials (for example, indium tin oxide or the like).

Specifically, the driving electrode layer 70 is disposed between the array substrate 10 and the opposite substrate 20. Specifically, both the common electrode 71 and the pixel electrodes 72 may be disposed on the array substrate 10. Alternatively, the pixel electrodes 72 may be disposed on the array substrate 10 while the common electrode 71 is disposed on the opposite substrate 20. As a specific arrangement of the present disclosure, the reflective display panel is applied to a TN-type liquid crystal display panel. At this time, the pixel electrodes 72 are disposed on the array substrate 10, and the common electrode 71 is disposed on the opposite substrate 20 and located on a side of the opposite substrate 20, adjacent to the nematic liquid crystal layer. When no electric field is generated between the pixel electrode 72 and the common electrode 71, the nematic liquid crystal layer of the corresponding pixel area P changes the polarization direction of the light; and when an electric field is generated between the pixel electrode 72 and the common electrode 71, the nematic liquid crystal layer of the corresponding pixel area P maintains the polarization direction of the light unchanged.

A manner of driving a nematic liquid crystal layer may be an existing Active Matrix (AM) driving mode, that is, connecting gate electrodes of thin-film transistors in the pixel areas P to the corresponding gate lines, connecting source electrodes of the thin-film transistors to data lines, and connecting drain electrodes of the thin-film transistors to the pixel electrodes; and providing scan signals to the thin-film transistors through the gate lines to control the source electrodes and the drain electrodes of the thin-film transistors to be turned on, thus transferring data signals on the data lines to the pixel electrodes, so as to generate electric field between the pixel electrodes 72 and the common electrode 71.

Specifically, the light adjustment portion 51 includes a cholesteric liquid crystal layer. A purpose of reflecting/transmitting light is realized by setting a specific material composition of the cholesteric liquid crystal layer or adjusting the state of the cholesteric liquid crystal layer.

Further specifically, in the first structure of the reflective display panel, as shown in FIG. 2, the cholesteric liquid crystal layer adopts a first cholesteric liquid crystal layer 51a of a solid state. The first cholesteric liquid crystal layer 51a includes chiral material with a birefringence index greater than or equal to 5, for example, binaphthalene. The first cholesteric liquid crystal layer 51a is used to reflect one of the left-rotation circularly-polarized light and the right-rotation circularly-polarized light, and transmit the other one. That is, if, when the photoelectric material layer 30 displays a bright state in the pixel area P it adjusts the light emitted from the circular polarizer 60 into the left-rotation circularly-polarized light, and when the photoelectric material layer 30 displays a dark state it adjusts the light emitted from the circular polarizer 60 into the right-rotation circularly-polarized light, the first cholesteric liquid crystal layer 51a is configured to reflect the left-rotation circularly-polarized light and transmit the right-rotation circularly-polarized light; and if, when the photoelectric material layer 30 displays a bright state in the pixel area P it adjusts the light emitted from the circular polarizer 60 into the right-rotation circularly-polarized light, and when the photoelectric material layer 30 displays a dark state it adjusts the light emitted from the circular polarizer 60 into the left-rotation circularly-polarized light, the first cholesteric liquid crystal layer 51a is configured to reflect the right-rotation circularly-polarized light and transmit the left-rotation circularly-polarized light.

The first cholesteric liquid crystal layers 51a of different pixel areas P are formed integratively. The first cholesteric liquid crystal layer 51a is disposed between the thin-film transistor 12 and the driving electrode layer 70, and the pixel electrode 72 is connected to the drain electrode of the thin-film transistor through a via hole penetrating through the first cholesteric liquid crystal layer 51a. The solar cell layer 40 is disposed between the first cholesteric liquid crystal layer 51a and the first substrate 11. Specifically, the solar cell layer 40 may be disposed between the thin-film transistor 12 and the first substrate 11, or the solar cell layer 40 may be disposed between the first cholesteric liquid crystal layer 51a and the thin-film transistor 12, so as to prevent the thin-film transistor 12 from affecting light collection of the solar cell layer 40.

It can be understood that the color of the light transmitted/reflected by the first cholesteric liquid crystal layer 51a are related to the pitch of the first cholesteric liquid crystal layer 51a. When the first cholesteric liquid crystal layer 51a has a single pitch, the color of the light reflected/transmitted by it is constant as well. In the present disclosure, the liquid crystal of the first cholesteric liquid crystal layer 51a is wideband cholesteric liquid crystal, such that different light rays may be transmitted/reflected by it. At this time, in order to realize color display, the opposite substrate 20 further includes a color light-filtering layer disposed on the second substrate 21, and the color light-filtering layer includes light-filtering portions 22 located in respective pixel areas P.

By taken that the circular polarizer 60 converts the external light into left-rotation circularly-polarized light, as an example, and in combination with FIG. 2 to FIG. 4b, the working principle of the reflective display panel in FIG. 2 will be described in details below.

In a first case, the first cholesteric liquid crystal layer 51a reflects right-rotation circularly-polarized light and transmits left-rotation circularly-polarized light.

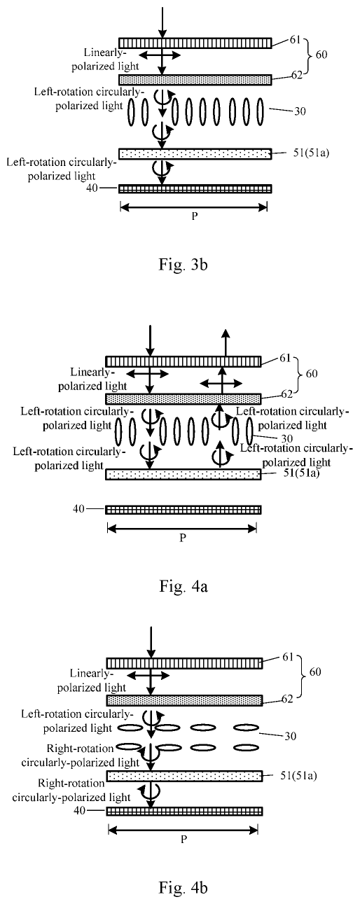

At this time, the principle of realizing a bright state of the pixel area P of the reflective display panel in FIG. 2 is as shown in FIG. 3a. After the external light passes through the linear polarizer 61, it becomes the linearly-polarized light, and after the linearly-polarized light passes through the quarter wave plate 62, it becomes the left-rotation circularly-polarized light. In the case where no electric field is applied between the common electrode 71 and the pixel electrode 72, the photoelectric material layer 30 (i.e., a nematic liquid crystal layer) converts the left-rotation circularly-polarized light into the right-rotation circularly-polarized light, and the right-rotation circularly-polarized light may be reflected by the first cholesteric liquid crystal layer 51a. After passing through the nematic liquid crystal layer, the reflected right-rotation circularly-polarized light is converted back into the left-rotation circularly-polarized light, and then, after passing through the quarter wave plate 62, it becomes the linearly-polarized light having the same polarization direction as that when it is the incident light, such that it may exit from the linear polarizer 61. At this time, the portion of the solar cell layer 40, located below the pixel area P, cannot receive light.

The principle of realizing a dark state of the pixel area P of the reflective display panel in FIG. 2 is as shown in FIG. 3b. After the external light passes through the linear polarizer 61, it becomes the linearly-polarized light, and after the linearly-polarized light passes through the quarter wave plate 62, it becomes the left-rotation circularly-polarized light. An electric field is applied between the common electrode 71 and the pixel electrode 72 to make the liquid crystal of the nematic liquid crystal layer be arranged vertically, such that the polarized state of the light is not changed and maintains as the left-rotation circularly-polarized light. The left-rotation circularly-polarized light is transmitted by the first cholesteric liquid crystal layer 51a, to realize the dark state. At the same time, the light transmitted by the first cholesteric liquid crystal layer 51a is received by the solar cell layer 40 below.

When the electric field intensity between the common electrode 71 and the pixel electrode 72 is smaller than the electric field intensity in FIG. 3b, the left-rotation circularly-polarized light is converted into right-rotation elliptically-polarized light by the nematic liquid crystal layer. The right-rotation elliptically-polarized light is decomposed into the right-rotation circularly-polarized light and the linearly-polarized light. The right-rotation circularly-polarized light is reflected by the first cholesteric liquid crystal layer 51a, such that the reflective display panel is in a state between the two states of FIG. 3a and FIG. 3b, to realize the display of different gray scales of intermediate states.

In a second case, the first cholesteric liquid crystal layer 51a reflects the left-rotation circularly-polarized light and transmits the right-rotation circularly-polarized light.

At this time, the principle of realizing a bright state of the pixel area P of the reflective display panel in FIG. 2 is as shown in FIG. 4a. After the external light passes through the linear polarizer 61, it becomes the linearly-polarized light, and after the linearly-polarized light passes through the quarter wave plate, it becomes the left-rotation circularly-polarized light. An electric field is applied between the common electrode 71 and the pixel electrode 72 to make the liquid crystal in the nematic liquid crystal layer be arranged vertically, such that the polarized state of the light is not changed and maintains as the left-rotation circularly-polarized light. The left-rotation circularly-polarized light may be reflected by the first cholesteric liquid crystal layer 51a, and then, after passing through the quarter wave plate 62, it becomes the linearly-polarized light having the same polarization direction as that when it is the incident light, such that it may exit from the linear polarizer. At this time, the portion of the solar cell layer 40, located below the pixel area P, cannot receive light.

The principle of realizing a dark state of the pixel area of the reflective display panel in FIG. 2 is as shown in FIG. 4b. After the external light passes through the linear polarizer 61, it becomes the linearly-polarized light, and after the linearly-polarized light passes through the quarter wave plate 62, it becomes the left-rotation circularly-polarized light. In the case where no electric field is applied between the common electrode 71 and the pixel electrode 72, the nematic liquid crystal layer converts the left-rotation circularly-polarized light into the right-rotation circularly-polarized light, and the right-rotation circularly-polarized light is transmitted by the first cholesteric liquid crystal layer 51a, to realize the dark state. At the same time, the light transmitted by the first cholesteric liquid crystal layer 51a is received by the solar cell layer 40 below.

When the electric field intensity between the common electrode 71 and the pixel electrode 72 is smaller than the electric field intensity in FIG. 4a, the left-rotation circularly-polarized light is converted into left-rotation elliptically-polarized light by the nematic liquid crystal layer. A portion of the left-rotation elliptically-polarized light is reflected by the first cholesteric liquid crystal layer 51a, such that the reflective display panel is in a state between the two states of FIG. 4a and FIG. 4b, to realize the display of different gray scales of intermediate states.

The above has described the working principle of the reflective display panel by taking that the circular polarizer 60 converts the external light into the left-rotation circularly-polarized light, as an example. The circular polarizer 60 may convert the external light into the right-rotation circularly-polarized light as well. In this case, the first cholesteric liquid crystal layer 51a may reflect the left-rotation circularly-polarized light and transmit the right-rotation circularly-polarized light, or reflect the right-rotation circularly-polarized light and transmit the left-rotation circularly-polarized light, the specific working process of which is similar to that of the above described. If the first cholesteric liquid crystal layer 51a reflects the left-rotation circularly-polarized light and transmits the right-rotation circularly-polarized light, when the pixel area P displays a bright state, a voltage between the common electrode 71 and the pixel electrode 72 may be adjusted, such that the nematic liquid crystal layer converts the right-rotation circularly-polarized light into the left-rotation circularly-polarized light; and when the pixel area P displays a dark state, the voltage between the common electrode 71 and the pixel electrode 72 may be adjusted, such that the nematic liquid crystal layer does not change the polarization state of the light. If the first cholesteric liquid crystal layer 51a reflects the right-rotation circularly-polarized light and transmits the left-rotation circularly-polarized light, when the pixel area P displays a bright state, the voltage between the common electrode 71 and the pixel electrode 72 may be adjusted, such that the nematic liquid crystal layer does not change the polarization state of the light; and when the pixel area P displays a dark state, the voltage between the common electrode 71 and the pixel electrode 72 may be adjusted, such that the nematic liquid crystal layer converts the right-rotation circularly-polarized light into the left-rotation circularly-polarized light.

The structure of the reflective display panel of the first structure has been described above. It can be seen that, when the pixel area P displays a dark state, the portion of the solar cell layer 40, corresponding to the pixel area P, may receive light. Therefore, as long as not all of the pixel regions P of the reflective display panel are in a bright state at the same time, the solar cell layer 40 may receive light. Furthermore, only the first cholesteric liquid crystal layer 51a of a solid state needs to be configured in the first structure of the light adjustment portion 51, such that the overall structure of the light adjustment layer 50 is simplified, thus it is easy to be produced and realized.

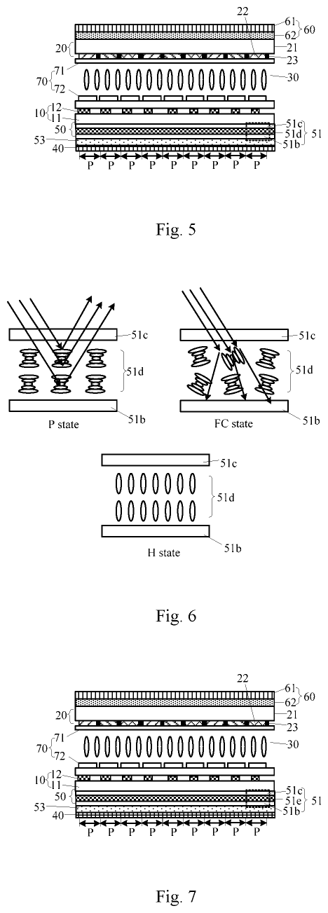

FIG. 5 is a schematic diagram of a second structure of a reflective display panel according to the first arrangement of the present disclosure. As shown in FIG. 5, the second structure is similar to the first structure. The following only introduces differences between the two structures.

The light adjustment portion 51 in FIG. 5 includes a cholesteric liquid crystal layer as well. Unlike the structure in FIG. 2, the cholesteric liquid crystal layer in FIG. 5 is in a liquid state, the liquid cholesteric liquid crystal layer has three different states: a planar texture state (i.e., a P state), a focal conic texture state (i.e., an FC state) and a vertical texture state (i.e., an H state).

Specifically, the liquid cholesteric liquid crystal layer is a second cholesteric liquid crystal layer 51d, and the second cholesteric liquid crystal layer 51d includes chiral material with a birefringence index less than or equal to 0.5. FIG. 6 is a schematic diagram illustrating that a second cholesteric liquid crystal layer is in different states. As shown in FIG. 6, the second cholesteric liquid crystal layer 51d is configured to, when it is in the planar texture state, reflect incident light, that is, reflects the incident light when it is planar-textured. When an electric field of a certain intensity is applied to the second cholesteric liquid crystal layer 51d, the second cholesteric liquid crystal layer 51d is converted from the planar texture state to the focal conic texture state, and at this time, the second cholesteric liquid crystal layer 51d can transmits the incident light. If a sufficiently high voltage is applied to the second cholesteric liquid crystal layer 51d, the second cholesteric liquid crystal layer 51d will be transformed into the vertical texture state. When the voltage applied on the second cholesteric liquid crystal layer of the vertical texture state rapidly drops to zero, the second cholesteric liquid crystal layer 51d may return to the planar texture state; but when the voltage is slowly lowered, the second cholesteric liquid crystal layer 51d will be transformed into the focal conic texture state. Both the planar texture state and the vertical texture state are steady states under zero electric field.

In order to control the state of the second cholesteric liquid crystal layer 51d, the light adjustment layer 50 in FIG. 5 further includes a first transparent electrode layer 51b and a second transparent electrode layer 51c, and the first transparent electrode layer 51b and the second transparent electrode layer 51c are configured to provide an electric field to the second cholesteric liquid crystal layer 51d, so as to control the second cholesteric liquid crystal layer 51d to be in the planar texture state or the focal conic texture state. Specifically, when the pixel area P is in a display state, the first transparent electrode layer 51b and the second transparent electrode layer 51c control the second cholesteric liquid crystal layer 51d to reach the planar texture state, so as to reflect the light emitted from the nematic liquid crystal layer to the second cholesteric liquid crystal layer 51d; and when the pixel area P is in a non-display state, the first transparent electrode layer 51b and the second transparent electrode layer 51c control the second cholesteric liquid crystal layer 51d to reach the focal conic texture state, so as to transmit the light emitted from the nematic liquid crystal layer to the second cholesteric liquid crystal layer 51d, thus making the solar cell layer 40 receive light.

Furthermore, the display states of the pixel area of the reflective display panel in FIG. 5 may include a bright state and an intermediate state as well. Taking that the circular polarizer 60 converts the external light into the left-rotation circularly-polarized light as an example, the working principle of the reflective display panel in FIG. 5 is as below.

When the pixel area P realizes a bright state display, the electric field between the common electrode 71 and the pixel electrode 72 is adjusted, such that the nematic liquid crystal layer converts the left-rotation circularly-polarized light from the circular polarizer 60 into the right-rotation circularly-polarized light, the right-rotation circularly-polarized light is reflected to the nematic liquid crystal layer by the second cholesteric liquid crystal layer 51d being in the planar texture state, and after passing through the nematic liquid crystal layer, the reflected right-rotation circularly-polarized light is converted back into the left-rotation circularly-polarized light, then after passing through the quarter wave plate 62, it becomes the linearly-polarized light having the same polarization direction as that when it is the incident light, such that it may exit from the linear polarizer. The electric field between the common electrode 71 and the pixel electrode 72 may be adjusted such that the nematic liquid crystal layer does not change the polarization state of light as well, and at this time, the light reflected by the second cholesteric liquid crystal layer 51d may exit from the linear polarizer 61 as well.

When the pixel area P realizes a dark state display, regardless of the state into which the left-rotation circularly-polarized light from the circular polarizer 60 is converted by the nematic liquid crystal layer, this portion of light may pass through the second cholesteric liquid crystal layer 51d being in the focal conic texture state.

When the left-rotation circularly-polarized light is converted into the elliptically-polarized light by the nematic liquid crystal layer by adjusting the electric field between the common electrode 71 and the pixel electrode 72, the elliptically-polarized light is reflected back to the nematic liquid crystal layer by the second cholesteric liquid crystal layer 51d being in the planar texture state, and the reflected elliptically-polarized light is still the elliptically-polarized light after passing through the nematic liquid crystal layer, such that a part of light may be emitted from the linear polarizer.

Similar to the first cholesteric liquid crystal layer 51a, the second cholesteric liquid crystal layer 51d adopts wideband cholesteric liquid crystal as well, such that the second cholesteric liquid crystal layer 51d corresponding to each of the pixel areas P may transmit/reflect a plurality of light with different colors.

In addition, in the second structure of the reflective display panel, both the liquid cholesteric liquid crystal layer (i.e., the second cholesteric liquid crystal layer 51d) and the solar cell layer 40 are located on a side of the array substrate, falling away from the photoelectric material layer. The second cholesteric liquid crystal layers 51d of the light adjustment portions 51 of different pixel areas P may be formed integrally.

Optionally, the reflective display panel may further include a third substrate 53 disposed on a side of the array substrate 10, away from the opposite substrate 20, and the cholesteric liquid crystal layer of a liquid state is located between the array substrate 10 and the third substrate 53. Furthermore, the first transparent electrode layer 51b and the second transparent electrode layer 51c may be located on two side of the liquid cholesteric liquid crystal layer respectively, the first transparent electrode layer 51b is located on the third substrate 53, and the second transparent electrode layer 51c may be located on the first substrate 11. At this time, the first transparent electrode layers 51b of the light adjustment portions 51 of different pixel areas P may be formed integrally, and the second transparent electrode layers 51c of the light adjustment portions 51 of different pixel areas P may be formed integrally. A package structure may be further provided between the first substrate 11 and the third substrate 53, for packaging the liquid cholesteric liquid crystal layer between the first substrate 11 and the third substrate 53.

The first transparent electrode layer 51b and the second transparent electrode layer 51c may be located on the same side of the liquid cholesteric liquid crystal layer.

FIG. 7 is a schematic diagram of a third structure of a reflective display panel according to the present disclosure. Similar to the second structure, in the third structure of the reflective display panel, the cholesteric liquid crystal layer is in a liquid state. The following only introduces differences between the third structure and the second structure of the reflective display panel.

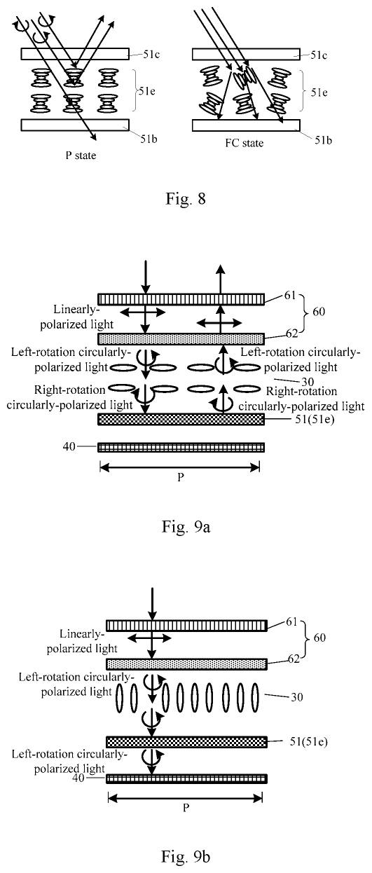

In the third structure of the reflective display panel, the liquid cholesteric liquid crystal layer is a third cholesteric liquid crystal layer 51e, and the third cholesteric liquid crystal layer 51e includes chiral material with a birefringence index greater than or equal to 5, for example, binaphthalene. FIG. 8 is a schematic diagram illustrating that a third cholesteric liquid crystal layer is in a planar texture state and a focal conic texture state. As shown in FIG. 8, the third cholesteric liquid crystal layer 51e is configured to, when it is in the focal conic texture state, transmit the incident light, and when it is in the planar texture state, reflect one of the left-rotation circularly-polarized light and the right-rotation circularly-polarized light and transmit the other one. FIG. 8 shows the case in which the third cholesteric liquid crystal layer 51e being in the planar texture state, reflects the left-rotation circularly-polarized light and transmits the right-rotation circularly-polarized light. It is possible to make the third cholesteric liquid crystal 51e being in the planar texture state to reflect the right-rotation circularly-polarized light and transmit the left-rotation circularly-polarized light as well.

In the following, taking that the circular polarizer 60 converts the external light into the left-rotation circularly-polarized light, as an example, the working principle of the reflective display panel in FIG. 7 will be described.

In a first case, the third cholesteric liquid crystal layer 51e is configured to, when it is in the focal conic texture state, transmit the incident light, and when it is in the planar texture state, reflect the right-rotation circularly-polarized light and transmit the left-rotation circularly-polarized light.

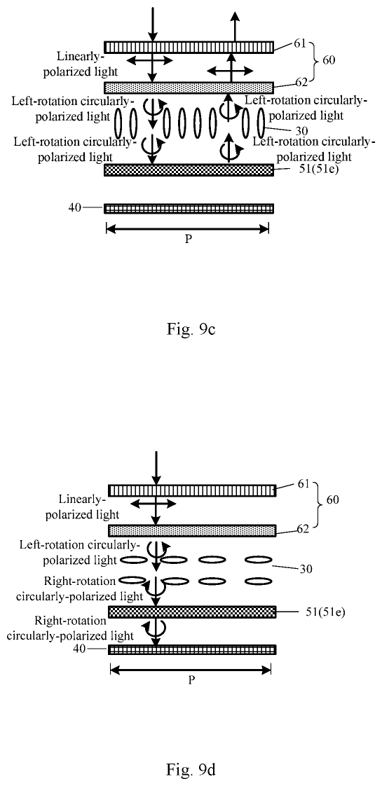

In this case, the principle of realizing a bright state of the pixel area P of the reflective display panel in FIG. 7 is as shown in FIG. 9a. After the external light passes through the linear polarizer 61, it becomes the linearly-polarized light, and after the linearly-polarized light passes through the quarter wave plate 62, it becomes the left-rotation circularly-polarized light. At this time, by adjusting the voltage between the first transparent electrode layer 51b and the second transparent electrode layer 51c, the third cholesteric liquid crystal layer 51e reaches and maintains the planar texture state; meanwhile, by adjusting the electric field between the common electrode 71 and the pixel electrode 72, the photoelectric material layer 30 (i.e., a nematic liquid crystal layer) converts the left-rotation circularly-polarized light into the right-rotation circularly-polarized light. The right-rotation circularly-polarized light may be reflected by the third cholesteric liquid crystal layer 51e, after passing through the nematic liquid crystal layer, the reflected right-rotation circularly-polarized light is converted back into the left-rotation circularly-polarized light, and then, after passing through the quarter wave plate 62, it becomes the linearly-polarized light having the same polarization direction as that when it is the incident light, such that it may exit from the linear polarizer. At this time, the portion of the solar cell layer 40, located below the pixel area P, cannot receive light.

The principle of realizing a dark state of the pixel area P of the reflective display panel in FIG. 7 is as shown in FIG. 9b. After the external light passes through the linear polarizer 61, it becomes the linearly-polarized light, and the linearly-polarized light becomes the left-rotation circularly-polarized light after passing through the quarter wave plate 62. At this time, the third cholesteric liquid crystal layer 51e maintains in the planar texture state; in addition, an electric field is applied between the common electrode 71 and the pixel electrode 72 to make the liquid crystal in the nematic liquid crystal layer be arranged vertically, such that the polarized state of the light is not changed and maintains as the left-rotation circularly-polarized light. The left-rotation circularly-polarized light is transmitted by the third cholesteric liquid crystal layer 51e, to realize the dark state; and at the same time, the light transmitted by the third cholesteric liquid crystal layer 51e is received by the solar cell layer 40 below.

When, by adjusting the electric field between the common electrode 71 and the pixel electrode 72, the left-rotation circularly-polarized light is converted into the right-rotation elliptically-polarized light and the third cholesteric liquid crystal layer 51e maintains in the planar texture state, the right-rotation elliptically-polarized light is decomposed into the right-rotation circularly-polarized light and the linearly-polarized light, and the right-rotation circularly-polarized light is reflected by the third cholesteric liquid crystal layer 51e, such that the reflective display panel is in a state between the two states of FIG. 9a and FIG. 9b, thus realizing the display of different gray scales of intermediate states.

In realizing the dark state display, it is possible by adjusting the voltage between the first transparent electrode layer 51b and the second transparent electrode layer 51c, to make the third cholesteric liquid crystal layer 51e reach the focal conic texture state as well. At this time, regardless of the state in which the light incident on the third cholesteric liquid crystal layer 51e is, this portion of light may pass through the third cholesteric liquid crystal layer 51e, thus realizing the dark state.

In a second case, the third cholesteric liquid crystal layer 51e is configured to, when it is in the focal conic texture state, transmit the incident light, and when it is in the planar texture state, reflect the left-rotation circularly-polarized light and transmit the right-rotation circularly-polarized light.

In this case, the principle of realizing a bright state of the pixel area P of the reflective display panel in FIG. 7 is as shown in FIG. 9c. After the external light passes through the linear polarizer 61, it becomes the linearly-polarized light, and the linearly-polarized light becomes the left-rotation circularly-polarized light after passing through the quarter wave plate 62. At this time, by adjusting the voltage between the first transparent electrode layer 51b and the second transparent electrode layer 51c, the third cholesteric liquid crystal layer 51e reaches and maintains the planar texture state; meanwhile, by adjusting the electric field between the common electrode 71 and the pixel electrode 72, the photoelectric material layer 30 does not change the polarization state of the light, and maintains as the left-rotation circularly-polarized light. The left-rotation circularly-polarized light may be reflected by the third cholesteric liquid crystal layer 51e, the reflected left-rotation circularly-polarized light after passing through the nematic liquid crystal layer is still the left-rotation circularly-polarized light, and then, after passing through the quarter wave plate 62, it becomes the linearly-polarized light having the same polarization direction as that when it is the incident light, such that it may exit from the linear polarizer 61. At this time, the portion of the solar cell layer 40, located below the pixel area P, cannot receive light.

The principle of realizing a dark state of the pixel area P of the reflective display panel in FIG. 7 is as shown in FIG. 9d. After the external light passes through the linear polarizer 61, it becomes the linearly-polarized light, and after passing through the quarter wave plate 62, the linearly-polarized light becomes the left-rotation circularly-polarized light. At this time, the third cholesteric liquid crystal layer 51e maintains in the planar texture state; in addition, the electric field between the common electrode 71 and the pixel electrode 72 is adjusted, such that the nematic liquid crystal layer converts the left-rotation circularly-polarized light into the right-rotation circularly-polarized light. The right-rotation circularly-polarized light is transmitted by the third cholesteric liquid crystal layer 51e, to realize the dark state; at this time, the light transmitted by the third cholesteric liquid crystal layer 51e is received by the solar cell layer 40 below.

When the electric field between the common electrode 71 and the pixel electrode 72 is adjusted, the nematic liquid crystal layer converts the left-rotation circularly-polarized light from the quarter wave plate 62 into the left-rotation circularly elliptically light, a part of the left-rotation elliptically-polarized light is reflected by the third cholesteric liquid crystal layer 51e, such that the reflective display panel is in a state between the two states of FIG. 9c and FIG. 9d, thus realizing the display of different gray scales of intermediate states.

In realizing the dark state of the pixel area P of the reflective display panel in FIG. 7, it is possible by adjust the voltage between the first transparent electrode layer 51b and the second transparent electrode layer 51c to make the third cholesteric liquid crystal layer 51e reach the focal conic texture state as well. At this time, regardless of the state in which the light incident on the third cholesteric liquid crystal layer 51e is, this portion of light may pass through the third cholesteric liquid crystal layer 51e, thus realizing the dark state.

The reflective display panel provided by the first arrangement has been described as the above. It can be seen that in the first arrangement, the position of the solar cell layer 40 is not necessarily limited to a coverage of the black matrix, but may cover the entire display area of the array substrate, which increases the light collection area of the solar cell layer 40; and by controlling the electric field intensity between the common electrode 71 and the pixel electrode 72, the deflection state of the nematic liquid crystal layer can be controlled, thus realizing the display of different gray scales.

Based on the above-described concept, according to a second arrangement of the present disclosure, a method of fabricating the above reflective display panel is provided, and the method includes:

Fabricating the array substrate and the opposite substrate respectively. The array substrate includes a first substrate, and structures such as thin-film transistors, gate lines, data line and the like disposed on the first substrate. The opposite substrate includes a second substrate, and a color light-filtering layer and a black matrix disposed on the second substrate.

Pairing the array substrate with the opposite substrate, and forming the photoelectric material layer located between the array substrate and the opposite substrate. Specifically, the photoelectric material layer may be a nematic liquid crystal layer.

Forming the solar cell layer and the light adjustment layer, such that both the solar cell layer and the light adjustment layer are located on a side of the photoelectric material layer, falling away from the opposite substrate, and the light adjustment is located between the solar cell layer and the photoelectric material layer.

As described above, the reflective display panel has three different structures as shown in FIG. 2, FIG. 5 and FIG. 7. In the following, fabricating methods for the reflective display panels of the two structures shown in FIG. 2 and FIG. 5 will be introduced in combination with the accompanying drawings.

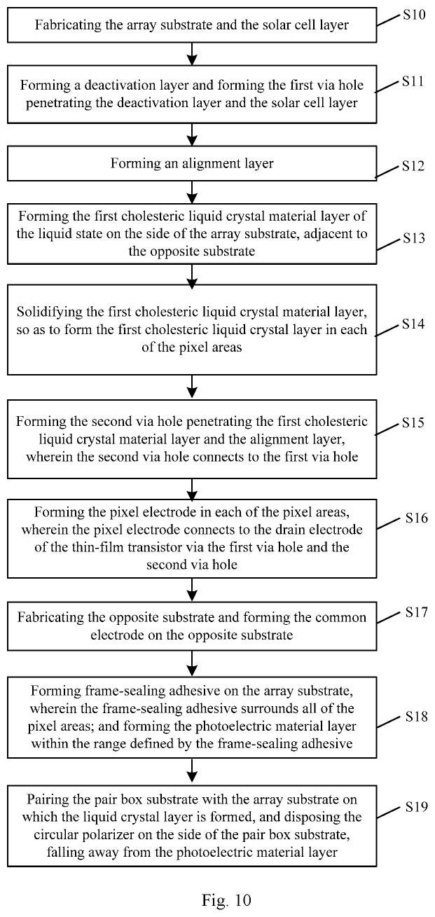

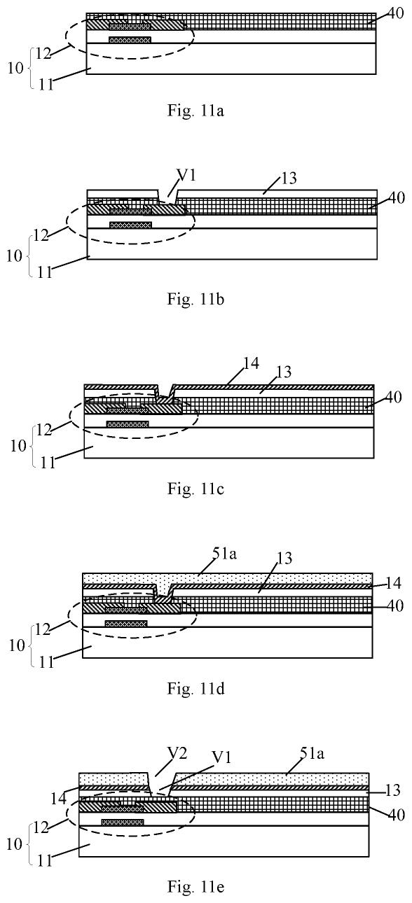

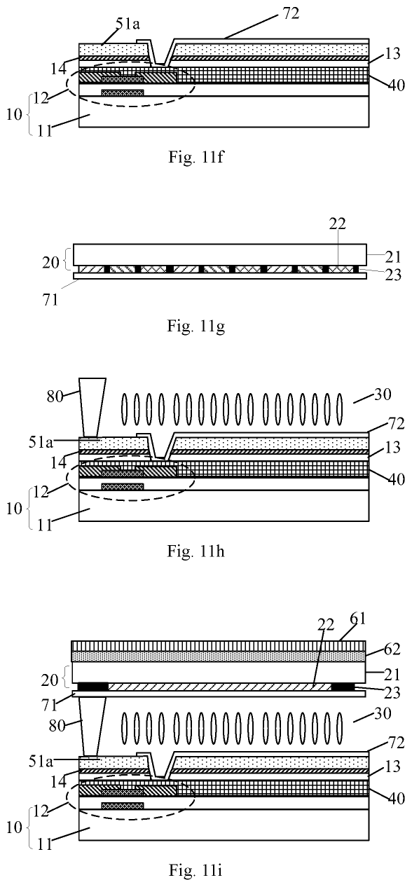

FIG. 10 is a first flow chart illustrating the fabrication of a reflective display panel according to the second arrangement of the present disclosure, which is used to fabricate the reflective display panel in FIG. 2. FIGS. 11a to 11i are schematic diagrams illustrating the process for fabricating a reflective display panel by adopting the fabricating method in FIG. 10. Combined with FIGS. 10 to 11i, the fabricating method includes the following blocks:

Block S10, fabricating the array substrate 10 and the solar cell layer 40. As shown in FIG. 11a, the array substrate 10 includes a first substrate 11, and structures such as thin-film transistors 12, gate lines, data lines and the like disposed on the first substrate 11, and the solar cell layer 40 is located on a side of the thin-film transistor 12, falling away from the first substrate 11. The solar cell layer 40 may be formed between the thin-film transistor 12 and the first substrate 11.

Block S11, forming a deactivation layer 13, and forming a first via hole V1 penetrating the deactivation layer 13 and the solar cell layer 40. The position of the first via hole V1 corresponds to the drain electrode of the thin-film transistor 12, as shown in FIG. 11b.

Block S12, forming an alignment layer, as shown in FIG. 11c.

Block S13, forming the first cholesteric liquid crystal layer of a liquid state on a side of the array substrate 10, adjacent to the opposite substrate.

S14. solidifying the first cholesteric liquid crystal layer, so as to form the first cholesteric liquid crystal layer 51a in each of the pixel areas, as shown in FIG. 11d. The first cholesteric liquid crystal layer 51a is configured to reflect the left-rotation circularly-polarized light and transmit the right-rotation circularly-polarized light, or reflect the right-rotation circularly-polarized light and transmit the left-rotation circularly-polarized light. The solidified first cholesteric liquid crystal layer 51a may meet the above optical property by adding an appropriate chiral material to the first cholesteric liquid crystal layer. The added chiral material includes binaphthalene. A solidifying manner for the first cholesteric liquid crystal layer may be ultraviolet irradiation.

S15. forming a second via hole V2 penetrating the first cholesteric liquid crystal layer 51a and the alignment layer 14. The second via hole V2 connects to the first via hole V1, as shown in FIG. 11e. The second via hole V2 may be formed via ashing.

S16. forming the pixel electrode 72 in each of the pixel areas. The pixel electrode 72 connects to the drain electrode of the thin-film transistor 12 via the first via hole and the second via hole, as shown in FIG. 11f.

S17. fabricating the opposite substrate 20, and forming the common electrode 71 on the opposite substrate 20. As shown in FIG. 11g, the opposite substrate 20 includes the second substrate 21, and the color light-filtering layer and the black matrix 23 disposed on the second substrate 21. The color light-filtering layer includes the light-filtering portion 22 located in each of the pixel areas. The common electrode 71 is located on a side of the color light-filtering layer, falling away from the second substrate 21.

S18. forming frame-sealing adhesive 80 on the array substrate 10. The frame-sealing adhesive 80 surrounds all of the pixel areas; and forming the photoelectric material layer 30 within a range defined by the frame-sealing adhesive 80. The photoelectric material layer 30 is a nematic liquid crystal layer, as shown in FIG. 11h.

S19. pairing the opposite substrate 20 with the array substrate 10 on which the liquid crystal layer 30 is formed, and disposing the circular polarizer on a side of the opposite substrate 20, falling away from the photoelectric material layer 30. Specifically, the circular polarizer 60 includes the linear polarizer 61 and the quarter wave plate 62 located between the linear polarizer 61 and the opposite substrate 20, as shown in FIG. 11i.

It should be noted that the order of the above blocks is not limited to the above sequence. For example, the block S17 may be performed before the block S10.

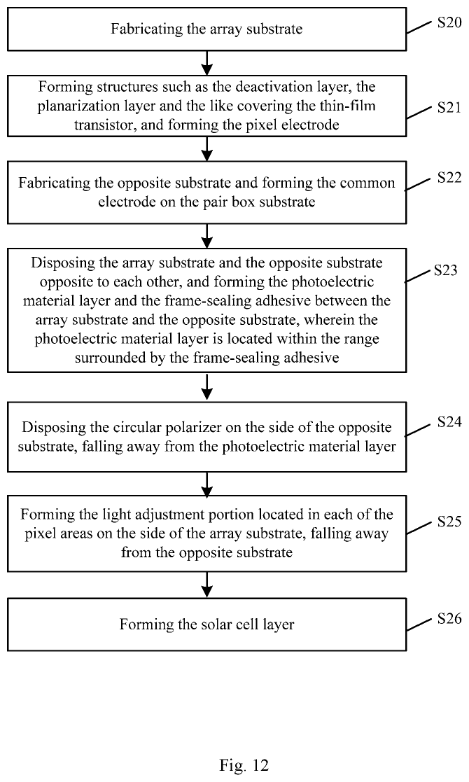

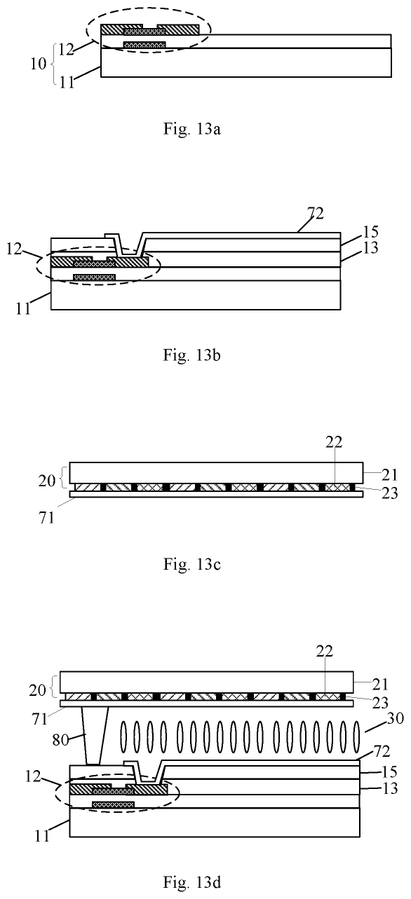

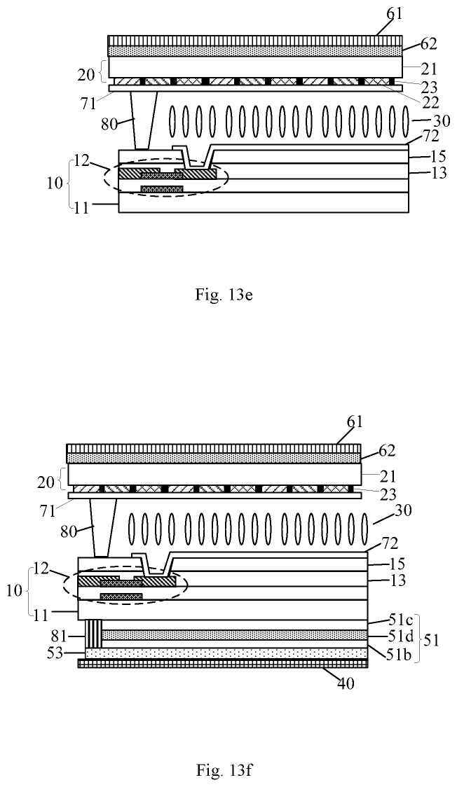

FIG. 12 is a second flow chart illustrating the fabrication of a reflective display panel according to the second arrangement of the present disclosure, which is used to fabricate the reflective display panel in FIG. 5. FIGS. 13a to 13f are schematic diagrams illustrating the process for fabricating a reflective display panel by adopting the fabricating method in FIG. 12. Combined with FIGS. 12 to 13f, the fabricating method includes the following blocks:

Block S20, fabricating the array substrate 10. As shown in FIG. 13a, the array substrate 10 includes the first substrate 11, and structures such as the thin-film transistors 12, gate lines, data lines and the like disposed on the first substrate 11.

Block S21, forming structures such as the deactivation layer 13, a planarization layer 15 and the like covering the thin-film transistor 12, and forming the pixel electrode 72 connecting to the drain electrode of the thin-film transistor 12 via a via hole penetrating the deactivation layer 13 and the planarization layer 15, as shown in FIG. 13b.

Block S22, fabricating the opposite substrate 20, and forming the common electrode 71 on the opposite substrate 20. As shown in FIG. 13c, the opposite substrate 20 includes the second substrate 21, and the color light-filtering layer and the black matrix 23 disposed on the second substrate 21. The color light-filtering layer includes the light-filtering portion 22 located in each of the pixel areas. The common electrode 71 is located on a side of the color light-filtering layer, falling away from the second substrate 21.

Block S23, disposing the array substrate 10 and the opposite substrate 20 opposite to each other, and forming the photoelectric material layer 30 and the frame-sealing adhesive 80 between the array substrate 10 and the opposite substrate 20. The photoelectric material layer 30 is located within a range surrounded by the frame-sealing adhesive 80, as shown in FIG. 13d. Specifically, the photoelectric material layer 30 is a nematic liquid crystal layer.

Block S24, disposing the circular polarizer 60 on a side of the opposite substrate 20, falling away from the photoelectric material layer 30. As shown in FIG. 13e, specifically, the circular polarizer 60 includes the linear polarizer 61 and the quarter wave plate 62 located between the linear polarizer 61 and the opposite substrate 20.

Block S25, forming the light adjustment portion 51 located in each of the pixel areas, on a side of the array substrate 10, falling away from the opposite substrate 20, as shown in FIG. 13f. The light adjustment portion 51 includes the second cholesteric liquid crystal layer 51d, the first transparent electrode layer 51b and the second transparent electrode layer 51c.

The first transparent electrode layers 51b of different pixel areas are formed integratively, the second transparent electrode layers 51c of different pixel areas are formed integratively, and the second cholesteric liquid crystal layers 51d of different pixel areas are formed integratively as well.

Specifically, in block S25, firstly, the second transparent electrode layer 51c may be formed on the first substrate 11 and the first transparent electrode layer 51b may be formed on the third substrate 53; secondly, a package structure 81 is formed on the first substrate 11 or the third substrate 53; thirdly, the second cholesteric liquid crystal layer 51d is formed within a range defined by the package structure 81; and finally, the third substrate 53 and the first substrate 11 are disposed opposite to each other and fixed together.

Block S26, forming the solar cell layer 40. As shown in FIG. 13f, the solar cell layer 40 is located on a side of the third substrate 53, falling away from the first substrate 11.

The order of the above blocks S23 to S25 is not limited to the above sequence. For example, the block S24 and the block S25 may be performed before the block S23.

The method of fabricating the reflective display panel of the third structure shown in FIG. 7 is the same as that of the reflective display panel of the second structure shown in FIG. 5. Only the second cholesteric liquid crystal layer 51d is required to be replaced by the third cholesteric liquid crystal layer 51e, which will not be described repeatedly here.

Based on the above-described concept, a third arrangement of the present disclosure provides a method of driving the above reflective display panels, and the driving method includes:

When the pixel area is in a display state, reflecting, via the light adjustment portion, at least a part of light emitted from the photoelectric material layer toward the light adjustment portion.

When the pixel area is in a non-display state, transmitting, via the light adjustment portion, light emitted from the photoelectric material layer toward the light adjustment portion.

The display state may include a bright state and an intermediate state.

When the reflective display panel adopts the structure shown in FIG. 2, the light that the first cholesteric liquid crystal layer is able to reflect is a first polarized light, and the light that the first cholesteric liquid crystal layer is able to transmit is a second polarized light. At this time, the driving method specifically includes:

When the pixel area is in the bright state, applying an electric field to the photoelectric material layer by using the driving electrode layer, so as to adjust the deflection state of the nematic liquid crystal in the photoelectric material layer, such that the photoelectric material layer adjusts the light emitted from the circular polarizer into the first polarized light. At this time, the first polarized light is reflected by the first cholesteric liquid crystal layer, such that the light emitted from the photoelectric material layer to the light adjustment portion is reflected via the light adjustment portion.

When the pixel area is in the intermediate state, applying an electric field to the photoelectric material layer by using the driving electrode layer, so as to adjust the deflection state of the nematic liquid crystal in the photoelectric material layer, such that the photoelectric material layer adjusts the light emitted from the circular polarizer into the elliptically-polarized light. The elliptically-polarized light may be discomposed into the first polarized light and the linearly-polarized light, that is, a part of the elliptically-polarized light is reflected by the first cholesteric liquid crystal layer. Thus, a part of light emitted from the photoelectric material layer to the light adjustment portion is reflected via the light adjustment portion.

When the pixel area is in the non-display state, applying an electric field to the photoelectric material layer by using the driving electrode layer, such that the photoelectric material layer adjusts the light emitted from the circular polarizer into the second polarized light, and the second polarized light is transmitted by the first cholesteric liquid crystal layer, such that the light emitted from the photoelectric material layer to the light adjustment portion is transmitted via the light adjustment portion.

The driving principle and working process of the reflective display panel shown in FIG. 2 have been described above, which are not repeatedly described here.

When the reflective display panel adopts the structure shown in FIG. 5, the driving method may include:

When the pixel area is in the display state, adjusting the voltage between the first transparent electrode layer and the second transparent electrode layer, to control the second cholesteric liquid crystal layer to be in the planar texture state, such that the light emitted from the photoelectric material layer to the second transparent electrode layer is reflected.

When the pixel area is in the non-display state, adjusting the voltage between the first transparent electrode layer and the second transparent electrode layer, to control the second cholesteric liquid crystal layer to be in the focal conic texture state, such that the light emitted from the photoelectric material layer to the second transparent electrode layer is transmitted.

When the reflective display panel adopts the structure shown in FIG. 7, the light that the third cholesteric liquid crystal layer being in the planar texture state is able to reflect is the first polarized light, and the light that the third cholesteric liquid crystal layer being in the planar texture state is able to transmit is the second polarized light. At this time, specifically, the driving method may include:

When the pixel area is in the bright state, adjusting the voltage between the first transparent electrode layer and the second transparent electrode layer, to control the third cholesteric liquid crystal layer to be in the planar texture state; at the same time, applying an electric field to the photoelectric material layer by using the driving electrode layer, such that the photoelectric material layer adjusts the light emitted from the circular polarizer into the first polarized light. At this time, the light emitted from the photoelectric material layer to the third cholesteric liquid crystal layer is reflected by the third cholesteric liquid crystal layer, such that the light emitted from the photoelectric material layer to the light adjustment portion is reflected via the light adjustment portion.

When the pixel area is in the intermediate state, adjusting the voltage between the first transparent electrode layer and the second transparent electrode layer, to control the third cholesteric liquid crystal layer to be in the planar texture state; at the same time, applying an electric field to the photoelectric material layer by using the driving electrode layer, such that the photoelectric material layer adjusts the light emitted from the circular polarizer into the elliptically-polarized light. At this time, a part of the elliptically-polarized light is reflected by the third cholesteric liquid crystal layer, such that a part of light emitted from the photoelectric material layer to the light adjustment portion is reflected via the light adjustment portion.

When the pixel area is in the dark state, keeping the third cholesteric liquid crystal layer in the planar texture state, at the same time, applying an electric field to the photoelectric material layer by using the driving electrode layer, such that the photoelectric material layer adjusts the light from the circular polarizer into the second polarized light, and the second polarized light is transmitted by the third cholesteric liquid crystal layer. Alternatively, adjusting the voltage between the first transparent electrode layer and the second transparent electrode layer, to control the third cholesteric liquid crystal layer to be in the focal conic texture state. At this time, the light incident on the third cholesteric liquid crystal layer may be reflected by the third cholesteric liquid crystal layer as well.

The driving principle and working process of the reflective display panel shown in FIG. 7 have been described above, which are not repeatedly described here.

Based on the above-described concept, a fourth arrangement of the present disclosure provides a display apparatus including the reflective display device of the above first arrangement. Since light collection area of the solar cell layer of the reflective display panel is increased, power consumption of the display apparatus adopting the reflective display panel is further decreased.

It can be understood that the above arrangements are merely exemplary arrangements employed to explain the principle of the present disclosure, yet the present disclosure is not limited thereto. For those skilled in the art, various modifications and improvements may be made without departing from the spirit and scope of the present disclosure, and such modifications and improvements are considered to be within the scope of the present disclosure as well.

What is claimed is:

1. A reflective display panel, comprising:
an array substrate;
an opposite substrate;
a photoelectric material layer;
a solar cell layer; and
a light adjustment layer, wherein
the array substrate and the opposite substrate disposed opposite to each other,
the photoelectric material layer is disposed between the array substrate and the opposite substrate,
the reflective display panel is divided into a plurality of pixel areas,
both the solar cell layer and the light adjustment layer are disposed on a side of the photoelectric material layer, falling away from the opposite substrate,
the light adjustment layer is disposed between the solar cell layer and the photoelectric material layer, and
the light adjustment layer comprises a light adjustment portion located in each of the pixel areas, and the light adjustment portion is configured to, when the corresponding pixel area is in a display state, reflect at least a part of light emitted from the photoelectric material layer toward the light adjustment portion, and when the corresponding pixel area is in a non-display state, transmit the light emitted from the photoelectric material layer toward the light adjustment portion.

2. The reflective display panel according to claim 1, wherein
a circular polarizer is disposed on a side of the opposite substrate, falling away from the photoelectric material layer,
the photoelectric material layer comprises a nematic liquid crystal layer, and
the reflective display panel further comprises a driving electrode layer, the driving electrode layer is configured to apply an electric field to the nematic liquid crystal layer, so as to use the nematic liquid crystal layer to transform light from the circular polarizer, between polarization states of left-rotation circularly-polarized light and right-rotation circularly-polarized light.

3. The reflective display panel according to claim 2, wherein the light adjustment portion comprises a cholesteric liquid crystal layer.

4. The reflective display panel according to claim 3, wherein the cholesteric liquid crystal layer comprises a first cholesteric liquid crystal layer of a solid state, and the first cholesteric liquid crystal layer is configured to reflect one of the left-rotation circularly-polarized light and the right-rotation circularly-polarized light, and transmit the other one of the left-rotation circularly-polarized light and the right-rotation circularly-polarized light.

5. The reflective display panel according to claim 4, wherein
the array substrate comprises a first substrate and a thin-film transistor disposed on the first substrate,
the first cholesteric liquid crystal layer is disposed between the thin-film transistor and the driving electrode layer, and
the solar cell layer is disposed between the first cholesteric liquid crystal layer and the first substrate.

6. The reflective display panel according to claim 4, wherein the first cholesteric liquid crystal layer comprises chiral material with a birefringence index greater than or equal to 5.

7. The reflective display panel according to claim 3, wherein
the cholesteric liquid crystal layer is in a liquid state,
the light adjustment portion further comprises a first transparent electrode layer and a second transparent electrode layer, and the first transparent electrode layer and the second transparent electrode layer are configured to provide an electric field to the cholesteric liquid crystal layer, so as to control the cholesteric liquid crystal layer to be in a planar texture state or a focal conic texture state, and
the cholesteric liquid crystal layer comprises a second cholesteric liquid crystal layer, and the second cholesteric liquid crystal layer is configured to, when the second cholesteric liquid crystal layer is in the focal conic texture state, transmit incident light, and when the second cholesteric liquid crystal layer is in the planar texture state, reflect the incident light, or,
the cholesteric liquid crystal layer comprises a third cholesteric liquid crystal layer, and the third cholesteric liquid crystal layer is configured to, when the third cholesteric liquid crystal layer is in the focal conic texture state, transmit the incident light, and when the third cholesteric liquid crystal layer is in the planar texture state, reflect one of the left-rotation circularly-polarized light and the right-rotation circularly-polarized light, and transmit the other one of the left-rotation circularly-polarized light and the right-rotation circularly-polarized light.

8. The reflective display panel according to claim 7, wherein
the second cholesteric liquid crystal layer comprises a chiral material with a birefringence index less than or equal to 0.5, and
the third cholesteric liquid crystal layer comprises a chiral material with a birefringence index greater than or equal to 5.

9. The reflective display panel according to claim 7, further comprising:
a third substrate disposed on a side of the array substrate, falling away from the opposite substrate, wherein
the cholesteric liquid crystal layer in the liquid state is located between the array substrate and the third substrate.

10. The reflective display panel according to claim 3, wherein
liquid crystal in the cholesteric liquid crystal layer is wideband cholesteric liquid crystal, and
the opposite substrate comprises a color light-filtering layer, and the color light-filtering layer comprises a light-filtering portion located in each of the pixel areas.

11. A display apparatus, comprising the reflective display panel according to claim 1.

12. A method of fabricating the reflective display panel according to claim 1, comprising:
fabricating the array substrate and the opposite substrate respectively;
disposing the array substrate and the opposite substrate opposite to each other, and forming the photoelectric material layer located between the array substrate and the opposite substrate; and
forming the solar cell layer and the light adjustment layer respectively, such that both the solar cell layer and the light adjustment layer are located on the side of the photoelectric material layer, falling away from the opposite substrate, and the light adjustment layer is located between the solar cell layer and the photoelectric material layer.

13. The method according to claim 12, wherein
the light adjustment layer comprises a light adjustment portion located in each of the pixel areas, the light adjustment portion comprises a cholesteric liquid crystal layer, the cholesteric liquid crystal layer comprises a first cholesteric liquid crystal layer of a solid state, and
the forming the light adjustment layer comprises:
forming the first cholesteric liquid crystal layer of a liquid state on the side of the array substrate, adjacent to the opposite substrate; and
solidifying the first cholesteric liquid crystal layer, to form the first cholesteric liquid crystal layer in each of the pixel areas.

14. A method of driving the reflective display panel according to claim 1, comprising:
when the corresponding pixel area is in the display state, reflecting, via the light adjustment portion, at least a part of the light emitted from the photoelectric material layer toward the light adjustment portion; and
when the corresponding pixel area is in the non-display state, transmitting, via the light adjustment portion, the light emitted from the photoelectric material layer toward the light adjustment portion.

15. The method according to claim 14, wherein
the light adjustment layer comprises a light adjustment portion located in each of the pixel areas, the light adjustment portion comprises a cholesteric liquid crystal layer, the cholesteric liquid crystal layer comprises a first cholesteric liquid crystal layer of a solid state, and
light that the first cholesteric liquid crystal layer is able to reflect is a first polarized light, and light that the first cholesteric liquid crystal layer is able to transmit is a second polarized light,
the reflecting, via the light adjustment portion, at least a part of the light emitted from the photoelectric material layer toward the light adjustment portion comprises: applying an electric field to the photoelectric material layer using a driving electrode layer, such that the photoelectric material layer adjusts the light emitted from the circular polarizer into the first polarized light or elliptically-polarized light; and
the transmitting, via the light adjustment portion, the light emitted from the photoelectric material layer toward the light adjustment portion comprises: applying an electric field to the photoelectric material layer using the driving electrode layer, such that the photoelectric material layer adjusts the light emitted from the circular polarizer into the second polarized light.

16. The method according to claim 14, wherein
the light adjustment layer comprises a light adjustment portion located in each of the pixel areas, the light adjustment portion comprises a cholesteric liquid crystal layer, the cholesteric liquid crystal layer is in a liquid state, the light adjustment portion further comprises a first transparent electrode layer and a second transparent electrode layer, and the first transparent electrode layer and the second transparent electrode layer are configured to provide an electric field to the cholesteric liquid crystal layer, so as to control the cholesteric liquid crystal layer to be in a planar texture state or a focal conic texture state, and the cholesteric liquid crystal layer comprises a second cholesteric liquid crystal layer or a third cholesteric liquid crystal layer, and
when the cholesteric liquid crystal layer comprises the second cholesteric liquid crystal layer,
the reflecting, via the light adjustment portion, at least a part of the light emitted from the photoelectric material layer toward the light adjustment portion comprises: adjusting a voltage between the first transparent electrode layer and the second transparent electrode layer, to control the second cholesteric liquid crystal layer to be in the planar texture state, and
the transmitting, via the light adjustment portion, the light emitted from the photoelectric material layer toward the light adjustment portion comprises: adjusting the voltage between the first transparent electrode layer and the second transparent electrode layer, to control the second cholesteric liquid crystal layer to be in the focal conic texture state; and
when the cholesteric liquid crystal layer comprises the third cholesteric liquid crystal layer, light that the third cholesteric liquid crystal layer being in the planar texture state is able to reflect is a first polarized light, and light that the third cholesteric liquid crystal layer is able to transmit is a second polarized light,
the reflecting, via the light adjustment portion, at least a part of the light emitted from the photoelectric material layer toward the light adjustment portion comprises: adjusting the voltage between the first transparent electrode layer and the second transparent electrode layer, to control the third cholesteric liquid crystal layer to be in the planar texture state, at the same time, applying an electric field to the photoelectric material layer using a driving electrode layer, such that the photoelectric material layer adjusts the light emitted from the circular polarizer into the first polarized light or elliptically-polarized light, and
the transmitting, via the light adjustment portion, the light emitted from the photoelectric material layer toward the light adjustment portion comprises: keeping the third cholesteric liquid crystal layer in the planar texture state, at the same time, applying an electric field to the photoelectric material layer using the driving electrode layer, such that the photoelectric material layer adjusts the light from the circular polarizer into the second polarized light, or adjusting the voltage between the first transparent electrode layer and the second transparent electrode layer, to control the third cholesteric liquid crystal layer to be in the focal conic texture state.
